(19) United States
(12) Patent Application Publication
(10) Pub. No.: US 2015/0283859 A1
(43) Pub. Date: Oct. 8, 2015

(54) REINFORCING BELT PACKAGE FOR RADIAL VEHICLE TIRES

(71) Applicant: KORDSA GLOBAL ENDÜSTRIYEL IPLIK VE KORD BEZI SANAYI VE TICARET ANON-IM SIRKETI, Kocaeli (TR)

(72) Inventors: Kürsat Aksoy, Kocaeli (TR); Bekir Anil Mertol, Kocaeli (TR); Sadettin Fidan, Garbsen (DE)

(73) Assignee: KORDSA GLOBAL ENDÜSTRIYEL IPLIK VE KORD BEZI SANAYI VE TICARET ANONIM SIRKETI, Kocaeli (TR)

(21) Appl. No.: 14/437,192

(22) PCT Filed: Oct. 11, 2013
(86) PCT No.: PCT/IB2013/002286

§ 371 Date: Apr. 20, 2015

(30) Foreign Application Priority Data
Oct. 18, 2012 (TR) 2012/12029

(51) Int. Cl. B60C 9/20; B60C 5/00; B60C 9/18; B60C 9/00

(52) U.S. Cl. CPC B60C 9/2009; B60C 9/005; B60C 5/00; B60C 9/1821; B60C 2009/2077; B60C 2001/0066

(57) ABSTRACT

The present invention relates to a reinforcing belt package for radial vehicle tires (1) which is wound between the tread and the carcass in tires used in motor vehicles, and essentially comprises at least one circumferential belt (2), which is formed by arranging metallic cords and polymeric cords next to each other in an alternating way, covered above and below with a rubber layer (3). This reinforcing belt package increases the cornering resistance and the life of the tire.

### FIELD OF THE INVENTION

The present invention relates to a reinforcing belt package for radial vehicle tires which is wound between the tread and the carcass in tires used in motor vehicles, increases the cornering resistance and their lifetime.

### BACKGROUND OF THE INVENTION

In the belt packages present in the radial vehicles tires used today, there is at least two cross belt layers and a circumferential belt reinforcement. The said cross belt layers are made of steel cords and provide the sufficient lateral and circumferential stiffness. However, there are a lot of cut ends in the said layers. The said cut ends affect the cord-rubber adhesion negatively, cause the tire dynamic to deteriorate by causing cracks at the edges of the layer. This requires the use of a separate belt layer(cap ply) for high speed performances.

European Patent document no EP1000972, an application known in the state of the art, discloses short-fiber reinforced rubber reinforcement belts in order to be used in vehicle tires. The steering stability and the rolling resistance of the vehicle is increased by means of the said belts.

European Patent document no EP1310385, another application known in the state of the art, discloses a vehicle tire comprising rubber layer reinforced with short fibers in the steel wire part which is under the rim. The said short fibers are directed towards the circumferential direction of the tire.

International Patent document no WO 2005/002884, another application known in the state of the art, discloses a tire comprising two conventional belt layer made of steel cords(working layers) and circumferential cap ply having alternating hybrid cords and lower modulus cords.

Japanese Patent document no JP2004217127 which is another application known in the state of the art, represents a motorcycle tire contains a regular steel breaker and additional layer with alternating steel and aramid cords.

Japanese Patent document no JP6 1119408 is another application known in the state of the art, which discloses that the short fibers having less than 1 micron lengths are used as filler in belt compounds. Increased compound modulus results are obtained by reducing shear strains. Those compounds are used together with conventional steel cords.

### SUMMARY OF THE INVENTION

The objective of the invention is to provide a reinforcing belt package for radial vehicle tires which is wound between the tread and the carcass of the tires.

Another objective of the present invention is to provide a reinforcing belt package for radial vehicle tires which increases the durability of the tire in cases wherein the vehicle should have good cornering stiffness and high speed performance.

A further objective of the present invention is to provide a reinforcing belt package for radial vehicle tires which comprises both metal cords and the polymeric cords.

Yet another objective of the present invention is to provide a reinforcing belt package for radial vehicle tires which is reinforced with short fibers.

### BRIEF DESCRIPTION OF THE DRAWINGS

The reinforcing belt package for radial vehicle tires to fulfill the objective of the present invention is illustrated in the accompanying figures wherein,

FIG. 1 is the transverse sectional view of the inventive reinforcing belt package for radial vehicle tires.

FIG. 2 is the cross sectional view of a vehicle tire on the inventive reinforcing belt package is applied.

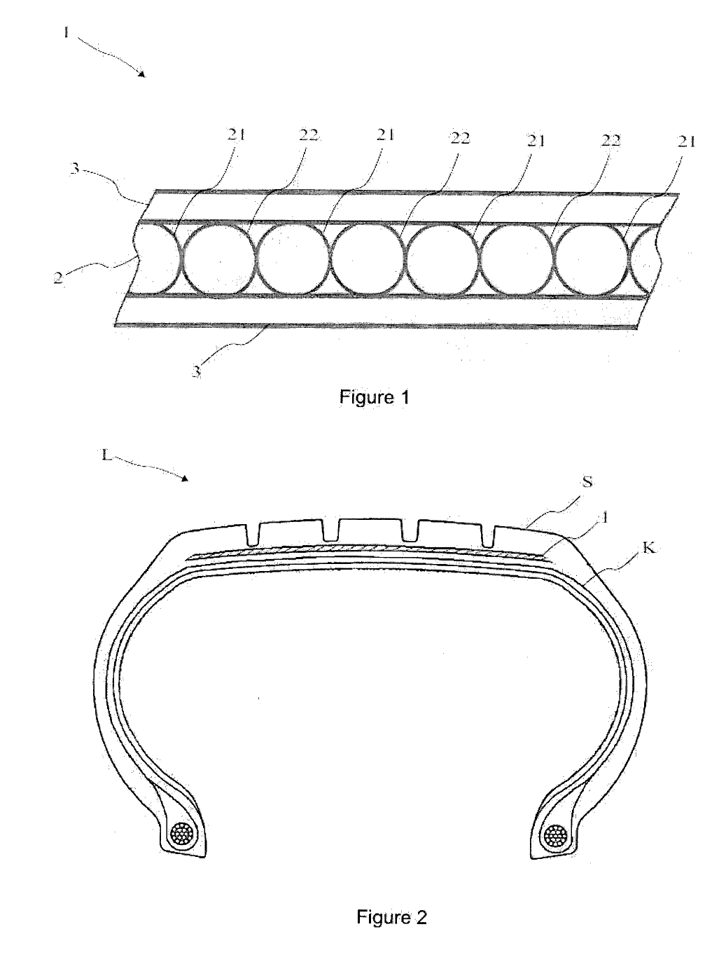

### DETAILED DESCRIPTION OF THE INVENTION

The components in the figures are assigned reference numerals as follows:
1. Reinforcing belt package
2. Circumferential belt
   21. Metallic cord (Steel cord)
   22. Polymeric cord
3. Rubber layer
S. Tread
K. Carcass
L. Tire

The inventive reinforcing belt package for radial vehicle tires (1) essentially comprises
at least one circumferential belt layer (2) which is formed by arranging the metallic cords (21) and the polymeric cords (22) following each other such that polymeric cord (22) will follow after the metallic cord (21), metallic cord (21) will follow after the polymeric cord (22),
at least one rubber layer (3) which covers above and below the circumferential belt layer (2).

The circumferential belt layer (2) is a strip layer between at least two rubber layers (3), and obtained by arranging the metal cords (21) comprised of twisted monofilaments and polymer cords (22) comprised of twisted monofilaments next to each other. In the preferred embodiment of the invention, the width of the circumferential belt strip (2) may vary between 5-25 mm. The distance between the cords (21, 22) is 0-0.25 mm based on the cord (21, 22) surfaces.

In the preferred embodiment of the invention, the metallic cord (21) is comprised of steel material. Nylon 6.6, nylon 4.6, polyethylene terephthalate, polyethylene naphthalate cords or aramide-nylon hybrid cords are used as polymeric cord (22).

In the preferred embodiment of the invention, the steel cords (21) are formed by twisting the monofilaments having the diameter of 0.12-0.45 mm. The said monofilaments can have normal, high, super and ultra breaking strength (NT, HT, ST and UT). Polymeric cords (22) are formed by twisting the monofilaments having the diameter of 0.1-0.5 mm.

In the preferred embodiment of the invention, the twist level of the steel cords (21) is 50-200 tpm (twist per meter), the twist length(lay length) is between 5-20 mm. The twist level of the polymeric cords (22) is between 20-500 tpm. Twist lengths of the steel and polymeric cords may be same or different.

The total end count (21, 22) is 50-250 epdm (ends per decimeter). The linear density of the steel cord (21) and the polymeric cord (22) can be equal or different.

The rubber layer (3) is a layer comprised of short fibers which are arranged transversally to the circumferential belt layer (2) such that it will resist to lateral compression and expansion of the belt (2). Two rubber layers (3) and the circumferential belt (2) are located inside the tire (L) such that they will form a sandwich. In the preferred embodiment of the invention, the short fibers are comprised of aramide, rayon, polyester and/or polyamide material. The elastic modulus of the short fiber used in the said rubber layer (3) is between 5-600 GPa.

The inventive reinforcing belt package for radial vehicle tires (1) is located between the tread (5) and carcass (K) layers of the tires (L). The said belt package (1) eliminates the metal-metal fretting and the wearing problem occurring as a result of the lateral compression in vehicle tires (L) during cornering and decreases the weight of the tire.

Furthermore, in the inventive belt package (1), the absence of the cut ends increases the durability and life of the tire (L).

Within the scope of these basic concepts, it is possible to develop various embodiments of the inventive reinforcing belt package for radial vehicle tires (1). The invention cannot be limited to the examples described herein; it is essentially as defined in the claims.

1. A reinforcing belt package for radial vehicle tires which is wound in strips between a tread and a carcass of a tires such that it will have 0-5° angle with the equatorial plane in order to increase the life of the tires by increasing the cornering resistance, comprising:
at least one circumferential belt which is formed by arranging a plurality of metallic cords and a plurality of polymeric cords following each other such that the polymeric cord will follow after the metallic cord, the metallic cord will follow after the polymeric cord; wherein the plurality of metal cords are obtained by twisting steel monofilaments, and the plurality of polymer cords are obtained by nylon 6.6, nylon 4.6, polyethylene terephthalate, polyethylene naphthalate or aramide-nylon hybrid monofilaments;
at least two rubber layers which cover above and below the circumferential belt wherein the rubber layers are comprised of short fibers comprised of aramide, rayon, polyester and/or polyamide material and arranged transversally to the circumferential belt in order to resist to lateral compression and expansion of the circumferential belt.

2. The reinforcing belt package for radial vehicle tires according to claim 1, wherein the circumferential belt is obtained by winding the strip having the width of 5-25 mm around carcass.

3. The reinforcing belt package for radial vehicle tires according to claim 1, wherein the distance between the cords is between 0-0.25 mm based on the cord surfaces.

4. The reinforcing belt package for radial vehicle tires according to claim 1, wherein the circumferential belt has a plurality of steel cords formed by twisting the monofilaments having the diameter of 0.12-0.45 mm.

5. The reinforcing belt package for radial vehicle tires according to claim 1, wherein the circumferential belt has the polymeric cords formed by twisting the monofilaments having the diameter of 0.1-0.5 mm.

6. The reinforcing belt package for radial vehicle tires according to claim 1, wherein the circumferential belt has a plurality of steel cords, the twist level of which is 50-200 tpm (twists per meter), and the twist length(lay length) of which is 5-20 mm.

7. The reinforcing belt package for radial vehicle tires according to claim 1, wherein the circumferential belt has the plurality of polymeric cords, and the twist level of which is 20-500 tpm (twists per meter).

8. The reinforcing belt package for radial vehicle tires according to claim 1, wherein the total end count of the cords is 50-250 epdm (ends per decimeter).

9. The reinforcing belt package for radial vehicle tires according to claim 1, wherein the two rubber layers have short filaments, the elastic modulus of which is between 5-600 GPa.
